(19) United States
(12) Patent Application Publication
(10) Pub. No.: US 2003/0184940 A1
(43) Pub. Date: Oct. 2, 2003

(54) Trip unit input method and device using a multiple conductor current transformer

(76) Inventors: Daniel Staver, Colorado Springs, CO (US); John Dougherty, Collegeville, PA (US); David Fletcher, Simsbury, CT (US)

Correspondence Address: CANTOR COLBURN, LLP, 55 GRIFFIN ROAD SOUTH, BLOOMFIELD, CT, 06002

(21) Appl. No.: 10/063,221

(22) Filed: Mar. 29, 2002

(51) Int. Cl. H02H 3/08

(52) U.S. Cl. 361/93.6

(57) ABSTRACT

A trip unit input circuit configured to generate a signal proportional to current in respective phase lines of a power line and to provide operational power from a corresponding primary current transformer, the circuit comprising: a current sensor circuit configured to provide an output signal indicative of current flow through a respective phase line; a secondary current transformer in operable communication with the corresponding primary current transformer; and a power supply circuit coupled to an output winding of the secondary transformer, the power supply circuit being isolated from the current sensor circuit by the secondary current transformer.

### BACKGROUND OF INVENTION

Current transformers are used to perform various functions in electrical circuits. Current transformers may be disposed on a primary electrical circuit to provide variable electrical power to a secondary electrical circuit. Current transformers may also be used as a sensor to sense electrical current in a primary electrical circuit and provide a signal indicative of the magnitude of the current to a secondary electrical circuit. In some applications, a single current transformer is used to perform both of these functions.

Modern circuit breakers often use electronic trip units to monitor the circuit breaker phase currents and trip the circuit breaker when needed. The electronic trip unit normally receives inputs from one or more current transformers. A single current transformer may be used to provide both operating power and a current signal to a secondary circuit in an electrical circuit breaker having an electronic trip unit. The interface between the current transformer and the trip unit is normally two wires. The current output from the current transformer provides both power for the trip unit and a sense signal representative of the primary phase current. Several circuits have been used in trip units to separate the power component from the sense component of the CT output signal.

Electronic trip units are employed in industrial-rated circuit breakers for a wide variety of protection and other accessory functions. One such electronic trip unit is described in U.S. Pat. No. 4,672,501 entitled Circuit Breaker and Protective Relay Unit.

An advantage of using a single current transformer to perform both power and sensing functions is the simplicity of a two-wire connection between the current transformers and the sensing circuitry (e.g. the trip unit). The sensing circuitry receives the sensing signal and power from two wires. One example of an efficient current transformer used for both sensing and power functions is described in U.S. Pat. No. 4,591,942 entitled Current Sensing Transformer Assembly.

However, previous two wire circuits have one or more drawbacks. These include full wave rectification, addition of undesirable DC offsets, and gain and phase distortion of the sense signal.

Newer sensor technologies often provide separate power and sensor connections, requiring four wires, two for providing power from the power transformer to the power supply circuitry and two for providing signals from the sensing device to the sensing circuitry. However, conventional electronic trip unit input circuits limit the use of newer sensor technologies since existing trip unit input circuits accept only a two wire input from conventional current transformers. The added wires can increase the cost to manufacture new devices. Moreover, the need for additional wires precludes using such current sensors with existing applications having a two conductor input.

The input circuit of an electronic trip unit having a two conductor input must separate the power and sensor components of the CT signals. Existing trip unit input circuits accomplish this in several ways. However, existing trip unit input circuits distort the sensor signals in one of several ways. Further, existing input trip unit input circuits preclude easy use of advanced sensors, which provide power and sensor signals in four wires.

Thus, there is a need for the power and sensor components of a CT signal to be separated in a trip unit input circuit to accomplish: minimum sensor signal distortion, bipolar sensor output, arbitrary sensor signal offset, and ready upgrade to other sensor types (i.e., four wire input).

### SUMMARY OF INVENTION

The above discussed and other drawbacks and deficiencies are overcome or alleviated by a trip unit input circuit configured to generate a signal proportional to current in respective phase lines of a power line and to provide operational power from a corresponding primary current transformer, the circuit comprising: a current sensor circuit configured to provide an output signal indicative of current flow through a respective phase line; a secondary current transformer in operable communication with the corresponding primary current transformer; and a power supply circuit coupled to an output winding of the secondary transformer, the power supply circuit being isolated from the current sensor circuit by the secondary current transformer.

### BRIEF DESCRIPTION OF DRAWINGS

Referring to the exemplary drawings wherein like elements are numbered alike in the several FIGURES:

FIG. 1 is a schematic illustration of a conventional trip unit input circuit for a circuit breaker using four current transformers;

FIG. 2 is a schematic illustration of an exemplary trip unit input circuit for a circuit breaker using the four primary and four secondary current transformers;

FIG. 3 is a schematic illustration of another exemplary trip unit input circuit for a circuit breaker using three primary and three secondary current transformers and a dedicated neutral current transformer for determining a ground fault;

FIG. 4 is a schematic illustration of another exemplary trip unit input circuit for a circuit breaker similar to the one depicted in FIG. 3 in which all four phase transformers apply power to the circuit supply and provides ground fault sensing and uses fewer diodes in the power supply creation; and

FIG. 5 is a schematic illustration of the exemplary trip unit input circuit of FIG. 2 coupled to primary current transformers having a four wire conductor or two output windings, which depicts the connection of a common signal return for all signals to the reference point on the circuit's A/D converter.

### DETAILED DESCRIPTION

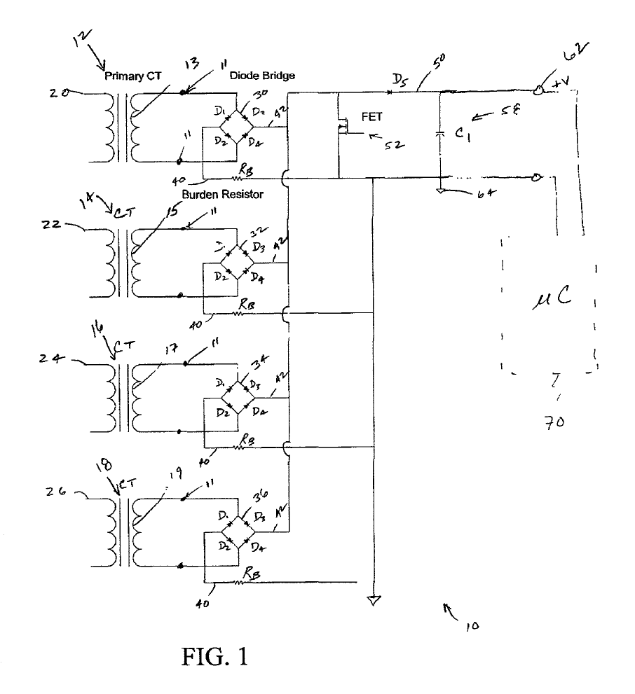

FIG. 1 illustrates a conventional trip unit input circuit 10 for a circuit breaker. Trip unit input circuit 10 interfaces each current transformer (CT) with a two conductor input, shown generally at 11 of an electronic trip unit (not shown). Trip unit input circuit includes line current from primary transformers 12, 14, 16 and 18. This arrangement would be used in trip units in which the neutral is metered and protected similarly to the three phases. Each primary transformer 12, 14, 16 and 18 is coupled to a respective power line 20, 22, 24 and 26. The current developed in the output winding 13, 15, 17 and 19 of each respective primary transformer 12, 14, 16 and 18 is supplied to a respective full wave bridge rectifier or diode bridge 30, 32, 34, and 36 with a simple capacitor filter C1. Current from each primary current transformer (CT), 12, 14, 16, and 18 provides an input to each full wave bridge rectifier 30, 32, 34, and 36 including bridge diodes comprising diodes D1, D2, D3, and D4. Each full wave bridge rectifier 30, 32, 34, and 36 creates a power supply negative power rail on a line 40 and an unfiltered and unregulated positive output voltage on a line 42. Diode D5 connected in series between the unfiltered output voltages on line 42 and the regulated output voltage on line 50 prevents current flow from capacitor C1 back to a regulator transistor (FET) 52. A filter section 58 for reducing the ripple of the unfiltered output voltage on line 42 is represented by the capacitor C1 connected between positive power rail 50 and negative power rail 40, creating a filtered output voltage on positive power rail 50. A source and drain of a field effect transistor (FET) 52 are connected to unfiltered voltage on line 42 and negative voltage rail 40, respectively. A logic signal by circuitry (not shown) drives the gate of FET 52 thereby shunting current through the FET 52 when the positive output rail is above the desired voltage and thus regulating the output voltage on line 50. The discharge capacitor C1 is coupled across output terminal 60 and ground 64 and in parallel with the series combination of a protection diode D5 and the control transistor FET 52. Diode D5 is coupled to output terminal 60 and in series with the output of each full wave rectifier or diode bridge 30, 32, 34, and 36.

In operation, line currents on power lines 20, 22, 24 and 26 are supplied to primary current transformers 12, 14, 16 and 18. Currents induced in the output windings 13, 15, 17 and 19 of primary transformers 12, 14, 16 and 18 are supplied to each respective full wave rectifier 30, 32, 34, and 36. If FET 52 is low, or in a nonconductive state, a voltage +V is developed at terminal 62 and is supplied to energize the circuit breaker trip unit having a microcontroller 70. Then the full wave rectified current flows through a burden resistor R_{B}. One R_{B} is disposed with each full wave rectifier or diode bridge 30, 32, 34, and 36 for obtaining a voltage Vₐ, V_{b}, V_{c} and V_{d} (where “d” refers to ground fault if power line 26 is a neutral line) are developed across each resistor R_{B}, respectively, by currents from output 42 of each full wave rectifier 30, 32, 34, and 36, respectively. The magnitude of each of voltages Vₐ, V_{b}, V_{c} and V_{d} is proportional to the line current in power line 20, 22, 24 and 26, respectively, and these voltages are supplied to the circuit breaker microcontroller of the ETU. Using voltages Vₐ, V_{b}, V_{c} and V_{d}, microcontroller 70 both detects faults and determines metering quantities.

The operation of all four circuits connected to each primary CT 12, 14, 16 and 18 is identical. The “Primary CT” causes alternating current to circulate in the secondary of the Primary CT. The “Diode Bridge” rectifies the circulating current and applies a full wave rectified current to the FET. The FET is turned ON or OFF by circuitry not shown in response to the voltage across the capacitor. The full wave rectified current flows through either the FET (i.e., FET ON) or the capacitor C₁ and external load (i.e., FET OFF). The full wave rectified current then flows through a current sensor circuit 160 comprising the “Burden Resistor”, resulting in a full wave rectified voltage across the burden resistor R_{B}. Since the right side of the burden resistor is at ground potential, the left side of the burden resistor has a full wave rectified signal below ground whose amplitude corresponds to the RMS value of current in the secondary of the CT.

Therefore, power circuit 10 satisfies the basic circuit breaker requirements, but nevertheless, includes full wave rectification, addition of undesirable DC offsets, and gain and phase distortion of the sense signal in current sensor circuit 160.

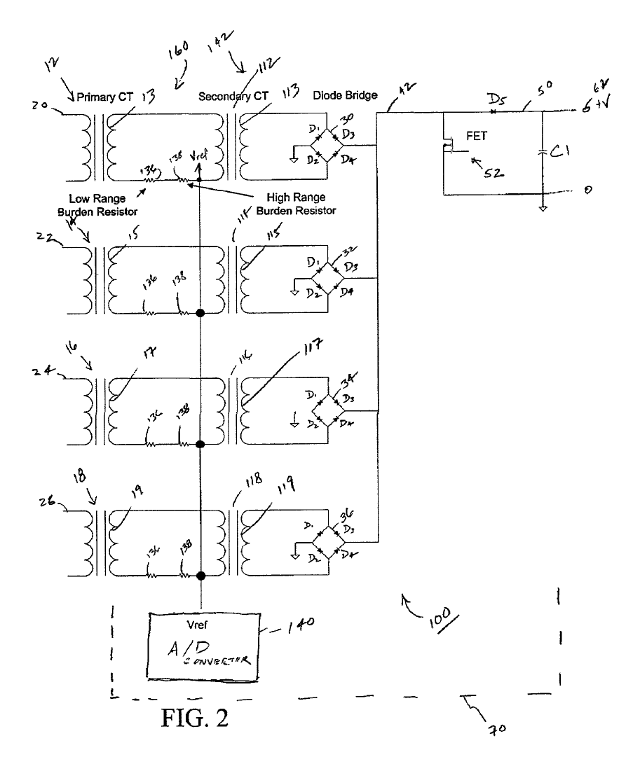

An exemplary embodiment of a trip unit input circuit 100 in accordance with one embodiment of this disclosure is illustrated in FIG. 2. Trip unit circuit 100 for a circuit breaker includes line current from primary transformers 12, 14 and 16 and a neutral current from primary transformer 18 each connected to a secondary transformer 112, 114, 116, and 118. Each primary transformer 12, 14, 16 and 18 is coupled to a respective power line 20, 22, 24 and 26. The current developed in the output winding 13, 15, 17 and 19 of each respective primary transformer 12, 14, 16 and 18 is supplied to respective secondary current transformers 112, 114, 116 and 118 having output windings 113, 115, 117, and 119, respectively, connected to the remaining circuit analogously to the output windings in the primary transformers in FIG. 1 except for a lack of burden resistors R_{B}. Each secondary CT 112, 114, 116, 118 preferably has a turns ratio close to 1:1 such that essentially the same current flows in the secondary of the secondary CT as flows in the primary of the secondary CT 12, 14, 16, 18. A pair of resistors 136 and 138 are coupled between each respective primary current transformer output windings 13, 15, 17, 19 and primary windings of each respective secondary transformer 112, 114, 116, 118. Each pair of resistors 136 and 138 includes one low range burden resistor 136 and one high range burden resistor 138 connected (serially) having a right side of each resistor 136, 138, as shown in FIG. 2, tied to a reference voltage V_{REF}. Reference voltage V_{REF} is preferably created from the secondary current transformer power source and, as such, can be a voltage level within the range of the analog to digital (A/D) converter 140. The dual burden resistors 136, 138 allow two ranges of current to be directly applied to the A/D converter 140 simultaneously with no further scaling by analog circuitry. For example, a low range burden consists of the signal across both resistor 136 and 138 may correspond to 200 mA RMS used to generate a current signal for 1× the rated current, while the high range burden resistor may correspond to 300 mA RMS used to generate a current signal for 15× the rated current. The right side of the high range burden resistor 138 is preferably referenced to A/D converter 140 reference voltage VREF, rather than to ground, as in FIG. 1. The low range burden resistor provides a current signal from a voltage across resistors 136 and 138 for metering and waveform capture functions, while the high range burden resistor provides a current signal from a voltage across resistor 138 for overcurrent protection. Thus, the above described circuit 100 provides a dual range, bipolar, correctly offset voltage representing the secondary current of the primary CT 12, 14, 16, and 18 that is proportional and indicative of the current. In addition, the secondary CT 112, 114, 116, 118 serves to isolate the rectified power supply path from the sensor voltages taken with respect to each burden resistor 136, 138, because the secondary current of the primary CT 12, 14, 16, 18 is not full wave rectified. It will be recognized that although two burden resistors are illustrated and described, a single burden resistor may be used.

In operation, line currents on power lines 20, 22, 24 and 26 are supplied to primary current transformers 12, 14, 16 and 18. Currents induced in the output windings 13, 15, 17 and 19 of primary transformers 12, 14, 16 and 18 are supplied to respective secondary current transformers 112, 114, 116 and 118 having output windings 113, 115, 117, and 119, respectively, connected to a remaining power supply circuit shown generally at 142. Power supply circuit 142 is analogous to the circuit shown to the right of output windings of the primary CTs 12, 14, 16 and 18 in FIG. 1, except for elimination of R_{B} in the output windings of the secondary CTs 112, 114, 116 and 118 in FIG. 2. More specifically, power supply circuit 142 includes the remaining input circuit 100 shown to the right of output windings 113, 115, 117 and 119 and its operation to supply operational power is analogous to that described for FIG. 1.

Using voltages taken across burden resistors 136 and 138 before being rectified, microcontroller 70 (shown with partial phantom lines) both detects faults and determines metering quantities using signals that are bipolar, thus allowing for a signal proportional to the current in any phase of the power line. Moreover, by supplying a reference voltage V_{REF} from the A/D converter 140, an accurate referenced signal is generated back to A/D converter 140 for microcontroller 70 to compare as opposed to using ground as a reference. Although two burden resistors 136, 138 are shown in FIG. 2, it will be understood that one or more than two burden resistors may be used to pick off voltages to generate any number of scaled current signals. For example, if a single burden resistor was used intermediate each primary and secondary CT, voltages Vₐ, V_{b}, V_{c} and V_{gf} (where “gf” refers to ground fault if one primary CT is for a dedicated neutral line) are developed across each of the resistors, respectively, by currents from the output windings of each primary CT, respectively. The magnitude of each of voltages Vₐ, V_{b}, V_{c} and V_{gf} is proportional to the line current in each power line 20, 22, 24 and 26, respectively, and these voltages are supplied to the circuit breaker microcontroller 70. Using voltages Vₐ, V_{b}, V_{c} and V_{gf} the microcontroller both detects faults and determines metering quantities.

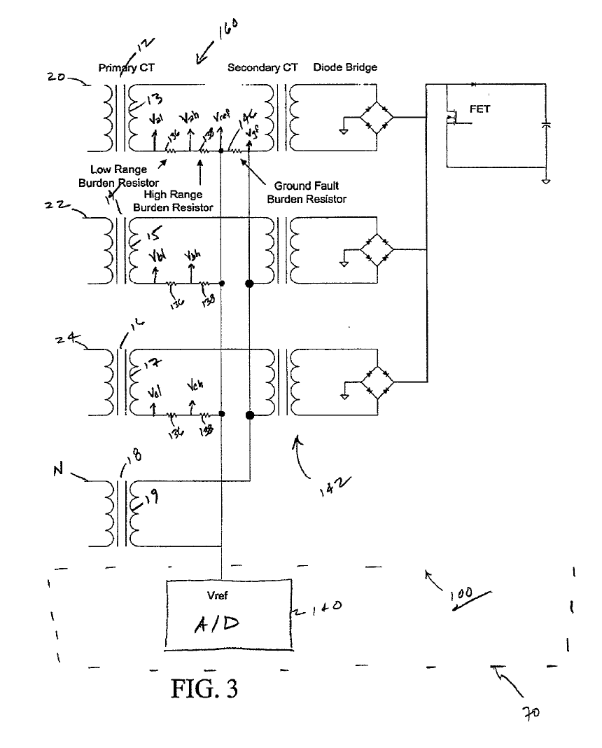

Referring to another exemplary embodiment of this disclosure, FIG. 3 shows a version of circuit 100 that would be used with three primary current CTs 12, 14 and 16 with three corresponding secondary CTs 112, 114, and 116 and a dedicated neutral CT 18 for neutral line N. The circuit 100 in FIG. 3 is similar to the circuit in FIG. 2, except that the return current of output windings 13, 15, 17 and 19 in all three phases and the neutral phase has been arranged to flow through a dedicated ground fault burden resistor 146 and the absence of a secondary CT coupled to dedicated neutral CT 18. This arrangement yields a voltage V_{gf} across the ground fault burden resistor 146 corresponding to an actual vector sum of the three phases and neutral current and can be directly measured by A/D converter 140 as ground fault current.

Still referring to FIG. 3, resistors 136 and 138 are coupled between each respective primary current transformer output windings 13, 15, 17, 19 and primary windings of each respective secondary transformer 112, 114, 116, 118. Each pair of resistors 136 and 138 includes one low range burden resistor 136 and one high range burden resistor 138 connected (serially) having a right side of the high range burden resistor 138, as shown in FIG. 2, tied to reference voltage V_{REF}. Reference voltage V_{REF} is preferably supplied from the secondary current transformer power source and, as such, can be a voltage level within the range of the analog to digital (A/D) converter 140. The dual burden resistors 136, 138 allow two ranges of current signals to be directly applied to the A/D converter 140 simultaneously with no further scaling by analog circuitry. For instance, voltages Vₐₕ, V_{bh} and V_{ch} would be supplied to three channels of A/D converter 140 with respect to voltages across respective high range burden resistors 138 in each of the three respective phases. Voltages Vₐₗ, V_{bl} and V_{cl} would be supplied to another three channels of A/D converter 140 with respect to voltages across respective low range burden resistor, (e.g., 136 and 138 combined), in each of the three respective phases. As in FIG. 2, power supply circuit operates to provide operational power as described with reference to FIG. 1.

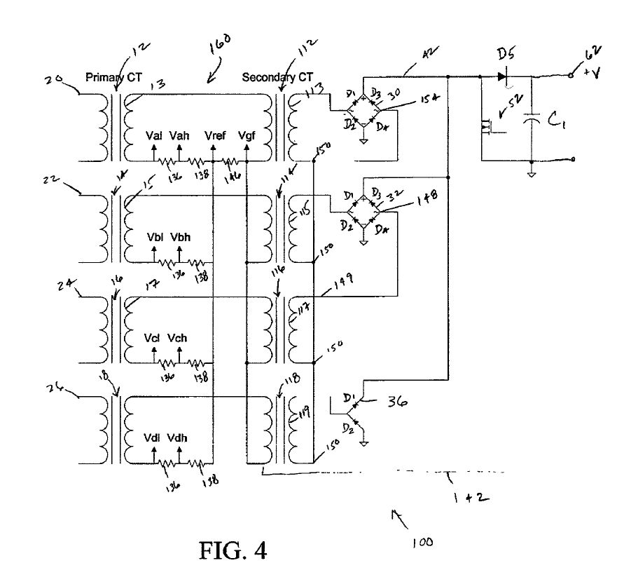

Yet another exemplary embodiment of this disclosure is shown in FIG. 4, in which the number of diodes used in power supply circuit 142 is reduced. FIG. 4 is a schematic representation of a circuit breaker trip unit employing input circuit 100 as in FIG. 2 and incorporating the dedicated ground fault resistor 146 of FIG. 3 while modifying power supply circuit 142. Modification of power supply circuit 142 includes using diode bridges 30 and 32 as in FIG. 2 except that diode bridge 32 includes an input 148 intermediate diodes D3 and D4 that is coupled to an output 149 of output winding 117 of secondary CT 116 because diode bridge 34 of FIG. 2 is eliminated. Two diodes, D3 and D4 are eliminated from diode bridge 36 in FIG. 4 resulting in a half diode bridge 36 having diodes D1 and D2. The elimination of diode bridge 34 and two diodes D3 and D4 from diode bridge 36 results in a total elimination of six diodes from input circuit 100. Lastly, it will be noted that one of the outputs 150 of each output winding 113, 115, 117 and 119 are coupled together at an input 154 intermediate diodes D3 and D4 of diode bridge 30. This known arrangement results in only the largest current signal at any one time supplied to the power circuit. This is advantageous during line fault conditions, in which the configurations of FIGS. 2, 3 and 5 will add the fault level currents, resulting in up to twice the fault current to be handled by the power supply circuitry. The remaining portion of power supply circuit 142 is configured as described in the aforementioned embodiments illustrated in FIGS. 2 and 3 and operates analogously.

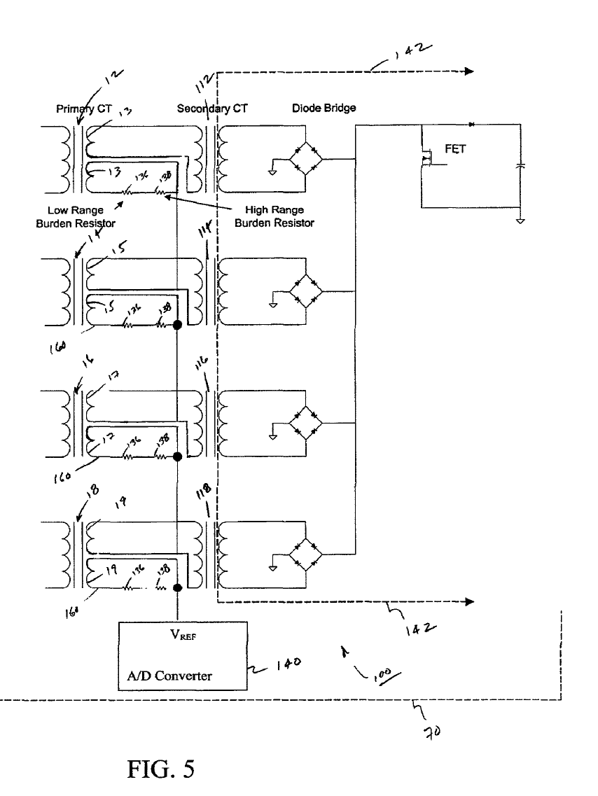

Referring now to FIG. 5, input circuit 100 illustrated and described with reference to FIG. 2 is shown coupled with four wire or having a pair of output windings 13, 15, 17 and 19 for each primary current transformer 12, 14, 16 and 18. It will be understood that although a two wire conductor output from a primary current transformer has been described in each of the disclosed embodiments, it is understood that a four wire conductor current sensor can be used by adapting input circuit 100. For example, one of the pair of output windings 13, 15, 17 and 19 is coupled to secondary current transformer 112, 114, 116 and 118 that in turn is coupled with power supply circuit 142 through a respective output winding of each secondary current transformer 112, 114, 116 and 118. The other output winding of each pair of output windings 13, 15, 17 and 19 is coupled to the current sensor circuit 160 having two output resistances 136 and 138 and V_{REF} in series. The two output resistances 136 and 138 correspond to a low range and high range burden resistor, as previously described. However, as before, a single burden resistor may be used.

The operation of input circuit 100 using a four conductor primary current transformer 12, 14, 16 and 18 in FIG. 5 parallels the operation as described with reference to FIG. 2 using a two wire conductor primary current transformer 12, 14, 16 and 18. Thus, a method is disclosed for using either a two or four wire conductor primary current transformer 12, 14, 16 and 18 with a trip unit input circuit disclosed herein.

The trip unit input circuits described herein provide the attributes of a highly accurate current sensor while providing operating power to a load circuit without requiring additional wires to be added between the current transformer and the input for the electronic trip unit (ETU). Thus, the ETU input circuit can be used to replace existing ETU input circuits, without having to modify the conventional ETU two wire conductor input. This disclosure describes a novel trip unit input circuit which overcomes the limitations of existing circuits. The new circuit separates the power and sensor components from the current transformer input signal without any of the compromises of previous methods. The circuit provides the sensing portions of the trip unit a highly accurate, bipolar signal with any needed DC offset and eliminates interactions between the sensing and power supply functions. It provides the power supply portions of the trip unit with a bipolar power signal. If needed, the bipolar power signal can be transformed in magnitude or limited in amplitude in extreme overcurrent conditions.

The trip unit input circuits described herein utilize a secondary current transformer inside the electronic trip unit to provide power. Previous implementations have used a secondary transformer for signals (to allow a separate signal path), but these implementations add an additional error element in the signal path. By providing power from internal transformers, the signal extraction requires only a sense resistor in series with the current transformer. The simpler signal paths provide easy extraction of multi-range phase signals as well as direct measurement of ground fault. The internal, power-only transformers can be combined in multi phase systems to save both transformer steel and losses.

While the invention has been described with reference to a preferred embodiment, it will be understood by those skilled in the art that various changes may be made and equivalents may be substituted for elements thereof without departing from the scope of invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A trip unit input circuit configured to generate a signal proportional to current in respective phase lines of a power line and to provide operational power from a corresponding primary current transformer, the circuit comprising:
a current sensor circuit configured to provide an output signal indicative of current flow through a respective phase line;
a secondary current transformer in operable communication with the corresponding primary current transformer; and
a power supply circuit coupled to an output winding of said secondary transformer, said power supply circuit being isolated from said current sensor circuit by said secondary current transformer.

2. The trip unit input circuit of claim 1 wherein said current sensor circuit is configured with an output resistance to provide said output signal.

3. The trip unit input circuit of claim 2 wherein said sensor circuit includes an external reference voltage applied to said output resistance.

4. The trip unit input circuit of claim 3 wherein said output resistance includes two burden resistors in series providing two current range signals.

5. The trip unit input circuit of claim 4 wherein said power supply circuit includes a diode bridge, said second output winding of said secondary current transformer being coupled to a corresponding said diode bridge.

6. The trip unit input circuit of claim 5 further comprising a control transistor coupled in parallel with said diode bridge so that when said transistor is in a nonconductive state, an output voltage is produced by said bridge rectifier.

7. The trip unit input circuit of claim 6 wherein said control transistor includes a field effect transistor (FET), said FET connecting through a diode and a capacitor.

8. A trip unit input circuit for generating a signal (Vₐ, V_{b}, V_{c} and V_{d}) proportional to current in a respective phase line of a power line and for generating operational power, said input circuit comprising:
a plurality of current sensor circuits, each sensor circuit in operable communication with a corresponding primary current transformers, each said current transformer having a first input winding coupled to the respective phase line to generate a current proportional to the current in the phase line and a first output winding connected to a corresponding current sensor circuit;
a plurality of output resistances, each one of said plurality of output resistances coupled to said corresponding current sensor circuit selected for generating a respective signal (Vₐ, V_{b}, V_{c} and V_{d}); and
a plurality of secondary current transformers, each of said secondary current transformers having a second input winding coupled to a corresponding said first output winding of said primary current transformer and a second output winding coupled to a respective power supply circuit for generating operational power.

9. The input circuit of claim 8 wherein each respective one of said output resistances is coupled to an external reference voltage.

10. The input circuit of claim 8 wherein each respective one of said output resistances includes two burden resistors in series, one end of said two burden resistors in series includes an external reference voltage (V_{ref}).

11. The input circuit of claim 10 wherein signals Vₐ, V_{b}, V_{c} and V_{d} comprise Vₐₕ, Vₐₗ, V_{bh}, V_{bl}, V_{ch}, V_{cl}, V_{dh} and V_{dl} corresponding to voltage signals generated with respect to corresponding said two burden resistors in series for each phase line.

12. The input circuit of claim 11 wherein said voltage signals are input into an A/D converter indicative of two ranges of current signals, said A/D converter supplying each respective one of said output resistances said external reference voltage.

13. The input circuit of claim 8 wherein each said power supply circuit includes a diode bridge, said second output winding of each secondary current transformer being coupled to a corresponding said diode bridge.

14. The input circuit of claim 13 further comprising a control transistor coupled in parallel with said diode bridge so that when said transistor is in a nonconductive state, an output voltage is produced by said bridge rectifier.

15. The input circuit of claim 14 wherein said control transistor includes a field effect transistor (FET), said FET connecting through a diode and a capacitor.

16. The input circuit of claim 8 wherein said power line includes a neutral phase line, one of said primary current transformers being coupled to said neutral phase line to develop an output signal Vₙ proportional to current in the neutral phase power line, wherein said first output winding of said one of said primary current transformer is coupled to a dedicated resistor to generate Vₙ.

17. The input circuit of claim 16 wherein said Vₙ is directly measured by an A/D converter as a ground fault current.

18. The input circuit of claim 16 further comprising said dedicated resistor being coupled to a return path for said first output winding of each of said primary current transformers, wherein a voltage across said dedicated resistor corresponds to a vector sum of three phases and said neutral phase line of said power line producing a signal V_{gf} proportional to a ground limit current derived from said vector sum of said voltages across said dedicated resistor.

19. The input circuit of claim 12 wherein said each second output winding of each said secondary current transformer includes a first output and a second output, each of said second outputs are coupled together at one input of a first diode bridge, another input of first diode bridge is coupled to said first output of a first secondary current transformer, an output of said first diode bridge is coupled to a cathode of diode D5 and a source of a control transistor, said first output of a second secondary current transformer is coupled to one input of a second diode bridge while a said first output of a third secondary current transformer is coupled to another input of said second diode bridge, an output of said second diode bridge is coupled to said cathode of said D5, said first output of a fourth output winding is coupled to a half diode bridge having an output coupled to said D5.

20. The input circuit of claim 19 further comprising a dedicated resistor being coupled to a return path for said first output winding of each of said primary current transformers, wherein a voltage across said dedicated resistor corresponds to a vector sum of three phases and said neutral phase line of said power line producing a signal Vgf proportional to a ground limit current derived from said vector sum of said voltages across said dedicated resistor.

21. A circuit breaker for providing overcurrent protection to load, the circuit breaker comprising:
a trip unit input circuit for generating signals (Vₐ, V_{b}, V_{c} and V_{d}) proportional to current in a respective phase line of a power line and for generating operational power, said input circuit including:
a plurality of current sensor circuits, each sensor circuit in operable communication with a corresponding primary current transformer, each said current transformer having a first input winding coupled to the respective phase line to generate a current proportional to the current in the phase line and a first output winding connected to a corresponding current sensor circuit;
a plurality of output resistances, each of said plurality of output resistances coupled to said corresponding current sensor circuit selected for generating one of said signals (Vₐ, V_{b}, V_{c} and V_{d}); and
a plurality of secondary current transformers, each of said secondary current transformers having a second input winding coupled to a corresponding said first output winding of said primary current transformer and a second output winding coupled to a respective power supply circuit for generating operational power.

22. The circuit breaker of claim 21 wherein each respective one of said output resistances is coupled to an external reference voltage.

23. The circuit breaker of claim 21 wherein each respective one of said output resistances includes two burden resistors in series, one end of said two burden resistors in series includes an external voltage source applying V_{ref}.

24. The circuit breaker of claim 23 wherein signals Vₐ, V_{b}, V_{c} and V_{d} comprise Vₐₕ, Vₐₗ, V_{bh}, V_{bl}, V_{ch}, V_{cl}, V_{dh} and V_{dl} corresponding to voltage signals generated with respect to corresponding said two burden resistors in series.

25. The circuit breaker of claim 24 wherein said voltage signals are input into an A/D converter indicative of two ranges of current signals, said A/D converter supplying each respective one of said output resistances an external reference voltage.

26. The circuit breaker of claim 21 wherein each said power supply circuit includes a bridge rectifier, said second output winding of each secondary current transformer being coupled to a corresponding said bridge rectifier.

27. The circuit breaker of claim 26 further comprising a control transistor coupled in parallel with said bridge rectifier so that when said transistor is in a nonconductive state, an output voltage is produced by said bridge rectifier.

28. The circuit breaker of claim 27 wherein said control transistor includes a field effect transistor (FET), said FET connecting through a diode and a capacitor.

29. The circuit breaker of claim 21 wherein said power line includes a neutral phase line, one of said primary current transformers being coupled to said neutral phase line to develop an output signal Vₙ proportional to current in the neutral phase power line, wherein said first output winding of said one of said primary current transformer is coupled to a dedicated resistor to generate Vₙ.

30. The circuit breaker of claim 29 wherein said Vₙ is directly measured by an A/D converter as a ground fault current.

31. The circuit breaker of claim 29 further comprising said dedicated resistor being coupled to a return path for said first output winding of each of said primary current transformers, wherein a voltage across said dedicated resistor corresponds to a vector sum of three phases and said neutral phase line of said power line producing a signal V_{gf} proportional to a ground limit current from a vector sum of said voltages across said dedicated resistor.

32. The circuit breaker of claim 25 wherein said each second output winding of each said secondary current transformer includes a first output and a second output, each of said second outputs are coupled together at one input of a first diode bridge, another input of first diode bridge is coupled to said first output of a first secondary current transformer, an output of said first diode bridge is coupled to a cathode of diode D5 and a source of a control transistor, said first output of a second secondary current transformer is coupled to one input of a second diode bridge while a said first output of a third secondary current transformer is coupled to another input of said second diode bridge, an output of said second diode bridge is couple to said cathode of said D5, said first output of a fourth output winding is coupled to a half diode bridge having an output coupled to said D5.

33. The circuit breaker of claim 32 further comprising a dedicated resistor being coupled to a return path for said first output winding of each of said primary current transformers, wherein a voltage across said dedicated resistor corresponds to a vector sum of three phases and said neutral phase line of said power line producing a signal V_{gf} proportional to a ground limit current from a vector sum of said voltages across said dedicated resistor.

34. A circuit breaker for providing overcurrent protection to load, the circuit breaker comprising:
a trip unit input circuit configured to generate a signal proportional to current in respective phase lines of a power line and to provide operational power from a corresponding primary current transformer, the circuit including,
a current sensor circuit configured to provide an output signal indicative of current flow through a respective phase line;
a secondary current transformer in operable communication with the corresponding primary current transformer; and
a power supply circuit coupled to an output winding of said secondary transformer, said power supply circuit being isolated from said current sensor circuit by said secondary current transformer.

35. The circuit breaker of claim 34 wherein said current sensor circuit is configured with an output resistance to provide said output signal.

36. The circuit breaker of claim 35 wherein said sensor circuit includes an external reference voltage applied to said output resistance.

37. The circuit breaker of claim 36 wherein said output resistance includes two burden resistors in series providing two current range signals.

38. The circuit breaker of claim 37 wherein said power supply circuit includes a diode bridge, said second output winding of said secondary current transformer being coupled to a corresponding said diode bridge.

39. The circuit breaker of claim 38 further comprising a control transistor coupled in parallel with said diode bridge so that when said transistor is in a nonconductive state, an output voltage is produced by said bridge rectifier.

40. The circuit breaker of claim 39 wherein said control transistor includes a field effect transistor (FET), said FET connecting through a diode and a capacitor.

41. A method of using a primary current transformer having a two or four wire conductor forming one or two output windings, respectively, with a trip unit input circuit in a circuit breaker, the method comprising:
adapting a current sensor circuit to provide an output signal indicative of current flow through a respective phase line of a power line;
coupling a first output winding of the primary current transformer to said current sensor circuit;
coupling a second output winding of the primary current transformer to a secondary current transformer; and
coupling a third output winding of said secondary current transformer to a power supply circuit configured to provide operational power to a trip unit with which said input circuit is in operable communication;
wherein said power supply circuit is isolated from said current sensor circuit by said secondary current transformer.

42. The method of claim 41 further comprising:
eliminating said second output winding of the primary current transformer; and
coupling said first output winding of the primary current transformer with said secondary current transformer forming an input winding on said secondary current transformer.

43. The method of claim 42 wherein the number of windings of said input winding and said third output winding on said secondary current transformer are about the same.

44. The method of claim 43 wherein said adapting said current sensor circuit includes:
a first and second burden resistor in series having a reference voltage V_{REF} supplied to one side of said first and second burden resistors in series, wherein said first burden resistor provides a voltage indicative of a first current range and said first and said second burden resistors provides a voltage indicative of a second current range.
